(19) United States
(12) Patent Application Publication
(10) Pub. No.: US 2026/0356065 A1
(43) Pub. Date: Nov. 12, 2026

(54) SHOE BODY WITH FOAMED MIDSOLE AND INJECTION OUTSOLE FORMED BY SUPERCRITICAL FOAMING INJECTION MOLDING AND METHOD FOR MANUFACTURING THE SAME

(71) Applicant: Grand Force Co., Ltd., Taichung City (TW)

(72) Inventor: JUI-FEN SHIAO, Taichung City (TW)

(73) Assignee: Grand Force Co., Ltd., Taichung City (TW)

(21) Appl. No.: 19/290,392

(22) Filed: Aug. 5, 2025

(30) Foreign Application Priority Data
May 12, 2025 (TW) 114117727

(51) Int. Cl. B29D 35/14; B29C 44/12; B29D 35/00; B29L 31/50

(52) U.S. Cl. CPC B29D 35/142; B29C 44/1271; B29D 35/0045; B29L 2031/504

(57) ABSTRACT

A method for manufacturing a shoe body with a foamed midsole and an injection outsole formed by supercritical foaming injection molding includes: providing an outsole module; injecting an injection material into the outsole mold chamber of the outsole module; opening the outsole module, wherein the injection outsole is fixed on a first outsole mold of the outsole module; providing a midsole module, wherein an upper, sleeved onto a shoe last, is pre-disposed on a midsole mold of the midsole module; disposing the first outsole mold with the injection outsole on the midsole mold; forming a midsole mold chamber between the injection outsole and the upper when the first outsole mold is sealed to the midsole mold; injecting a foaming material into the midsole mold chamber to form the foamed midsole and integrally bond the foamed midsole between the upper and the injection outsole, thereby obtaining the shoe body.

### BACKGROUND OF THE INVENTION

### Technical Field

The present invention relates generally to a technique of manufacturing a shoe body, and more particularly to a shoe body with a foamed midsole and an injection outsole formed by supercritical foaming injection molding and a method for manufacturing the same.

### DESCRIPTION OF RELATED ART

In the current conventional shoe manufacturing process, an upper, a midsole, and an outsole are separately produced. Surface treatment is then manually performed on the upper, the midsole, and the outsole. Subsequently, the upper and the outsole are respectively bonded to opposite sides of the midsole using an adhesive, thereby forming a shoe body.

However, in the conventional shoe manufacturing process, the midsole and the outsole are typically formed separately using individual molds for foaming injection and injection molding, respectively. Different molds are often developed for the midsole and the outsole according to the required patterns and shapes, which increases the overall mold cost. In addition, conventional processes require significant manual labor during adhesive application and sole attachment steps, reducing overall production efficiency. The chemical adhesives used during the gluing process might also pose risks to human health. Moreover, the bonding strength between the midsole and the outsole is often inadequate. When a wearer engages in high-intensity activities over an extended period, the midsole and the outsole might become separated, increasing the risk of injury.

Some shoe manufacturers have developed a co-molding process that integrates an injection outsole and a foamed midsole. In actual production, the outsole is first formed using an outsole mold through injection molding. The outsole is then removed from the outsole mold and placed into a midsole mold for foaming injection molding. During the foaming of the midsole, the outsole and the midsole are bonded together. However, this process still requires the preparation of separate molds for the outsole and the midsole, which cannot be shared. Furthermore, before the outsole is placed into the midsole mold for co-molding and foaming, the outsole still requires manual trimming and material refilling. Therefore, even with this co-molding process, the issues of mold cost and labor cost remain unresolved, indicating room for improvement in the manufacturing process.

### BRIEF SUMMARY OF THE INVENTION

In view of the above, the primary objective of the present invention is to provide a shoe body with a foamed midsole and an injection outsole formed by supercritical foaming injection molding and a method for manufacturing the same. The method could effectively reduce mold costs, eliminate manual steps of gluing, outsole attaching, and material refilling, and enhance the overall process efficiency.

The inventive subject matter provides the method for manufacturing the shoe body with the foamed midsole and the injection outsole formed by supercritical foaming injection molding, wherein the shoe body includes the injection outsole, the foamed midsole, and an upper. The foamed midsole is bonded between the upper and the injection outsole. The method includes the following steps.

step S1: providing an outsole module, wherein the outsole module includes a first outsole mold and a second outsole mold; the first outsole mold includes an outsole mold cavity, a plurality of first injection channels, and a plurality of second injection channels, wherein the first injection channels and the second injection channels are connected to the outsole mold cavity; a plurality of protruding tubes are disposed on the outsole mold cavity and are respectively in communication with the second injection channels; the second outsole mold includes an outsole part, wherein a plurality of shielding grooves are disposed on the outsole part; the shielding grooves correspond to a plurality of positions of the protruding tubes;

step S2: sealing the first outsole mold to the second outsole mold to form an outsole mold chamber between the outsole mold cavity and the outsole part, wherein the protruding tubes and the second injection channels are sealed by the shielding grooves; the first injection channels are in communication with the outsole mold chamber;

step S3: injecting an injection material into the outsole mold chamber through the first injection channels, so as to form the injection outsole from the injection material;

step S4: opening the first outsole mold and the second outsole mold, with the injection outsole remaining on the outsole mold cavity of the first outsole mold; a plurality of through holes are disposed on the injection outsole and are respectively sleeved onto the protruding tubes;

step S5: providing a midsole module, disposing the first outsole mold with the injection outsole on the midsole mold, and positioning the injection outsole to face the upper, wherein the midsole module includes a midsole mold including an upper receiving groove, and the upper, sleeved onto a shoe last, is pre-disposed in the upper receiving groove;

step S6: forming a midsole mold chamber between the injection outsole and the upper when the first outsole mold is sealed to the midsole mold, wherein the midsole mold chamber is in communication with the through holes and the second injection channels; and

step S7: injecting a foaming material including a supercritical fluid into the midsole mold chamber through the second injection channels and the through holes, so as to foam and mold the foaming material to form the foamed midsole, and to integrally bond the foamed midsole between the upper and the injection outsole, thereby obtaining the shoe body.

The inventive subject matter further provides the shoe body with the foamed midsole and the injection outsole formed by supercritical foaming injection molding including an injection outsole, a foamed midsole, and an upper. The injection outsole includes a first top surface and a first bottom surface, wherein a plurality of through holes are distributed on the injection outsole. The through holes penetrate the first top surface and the first bottom surface. The foamed midsole includes a second top surface and a second bottom surface, wherein the second bottom surface is bonded to the first top surface. The foamed midsole includes a plurality of protrusions located on the second bottom surface. The protrusions are correspondingly embedded in the through holes of the injection outsole. The upper bonded to the foamed midsole, wherein the upper includes a bottom surface. The bottom surface is bonded to the second top surface of the foamed midsole.

In the method for manufacturing the shoe body with the foamed midsole and the injection outsole formed by supercritical foaming injection molding, any adhesive application and outsole attaching steps are omitted. After the injection outsole is formed in the outsole module, the first outsole mold with the injection outsole is directly sealed to the midsole mold of the midsole module. Therefore, a step of removing the injection outsole from the outsole module, as well as subsequent trimming and material-filling processes, is omitted. When the first outsole mold is sealed to the midsole mold, the foamed midsole is integrally foamed and molded within the midsole mold chamber, and is co-molded with the upper and the injection outsole to form the shoe body. Accordingly, the method for manufacturing the shoe body with the foamed midsole and the injection outsole formed by supercritical foaming injection molding, compared to conventional manufacturing techniques, not only improves process efficiency, but also reduces mold and labor costs, and even enhances the production yield of the shoe body.

In the shoe body with the foamed midsole and the injection outsole formed by supercritical foaming injection molding, the foamed midsole is bonded between the upper and the injection outsole, without any adhesive layer between the foamed midsole and the upper, or between the foamed midsole and the injection outsole. Moreover, the protrusions of the foamed midsole are correspondingly embedded in the through holes of the injection outsole, thereby enhancing the bonding strength between the foamed midsole and the injection outsole and improving the overall bonding performance.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flowchart of the method for manufacturing the shoe body with the foamed midsole and the injection outsole formed by supercritical foaming injection molding according to an embodiment of the present invention, showing step S1 to step S3 of the method;

FIG. 2 is a flowchart of the method for manufacturing the shoe body with the foamed midsole and the injection outsole formed by supercritical foaming injection molding according to the embodiment of the present invention, showing step S4 to step S7 of the method;

FIG. 3 is a sectional schematic view of the method for manufacturing the shoe body with the foamed midsole and the injection outsole formed by supercritical foaming injection molding according to the embodiment of the present invention, showing that the injection material is injected into the outsole module;

FIG. 4 is a sectional schematic view of the method for manufacturing the shoe body with the foamed midsole and the injection outsole formed by supercritical foaming injection molding according to the embodiment of the present invention, showing that the injection outsole is obtained by opening the outsole module;

FIG. 5 is a top view of the method for manufacturing the shoe body with the foamed midsole and the injection outsole formed by supercritical foaming injection molding according to the embodiment of the present invention, showing the injection outsole;

FIG. 6 is a sectional schematic view of the method for manufacturing the shoe body with the foamed midsole and the injection outsole formed by supercritical foaming injection molding according to the embodiment of the present invention, showing that the first outsole mold is sealed to the midsole mold;

FIG. 7 is a sectional schematic view of the method for manufacturing the shoe body with the foamed midsole and the injection outsole formed by supercritical foaming injection molding seen from another perspective according to the embodiment of the present invention, showing that the first outsole mold is sealed to the midsole mold;

FIG. 8 is a sectional schematic view of the method for manufacturing the shoe body with the foamed midsole and the injection outsole formed by supercritical foaming injection molding according to the embodiment of the present invention, showing that the foaming material is injected into the midsole mold chamber;

FIG. 9 is a side view of the shoe body with the foamed midsole and the injection outsole formed by supercritical foaming injection molding according to another embodiment of the present invention.

### DETAILED DESCRIPTION OF THE INVENTION

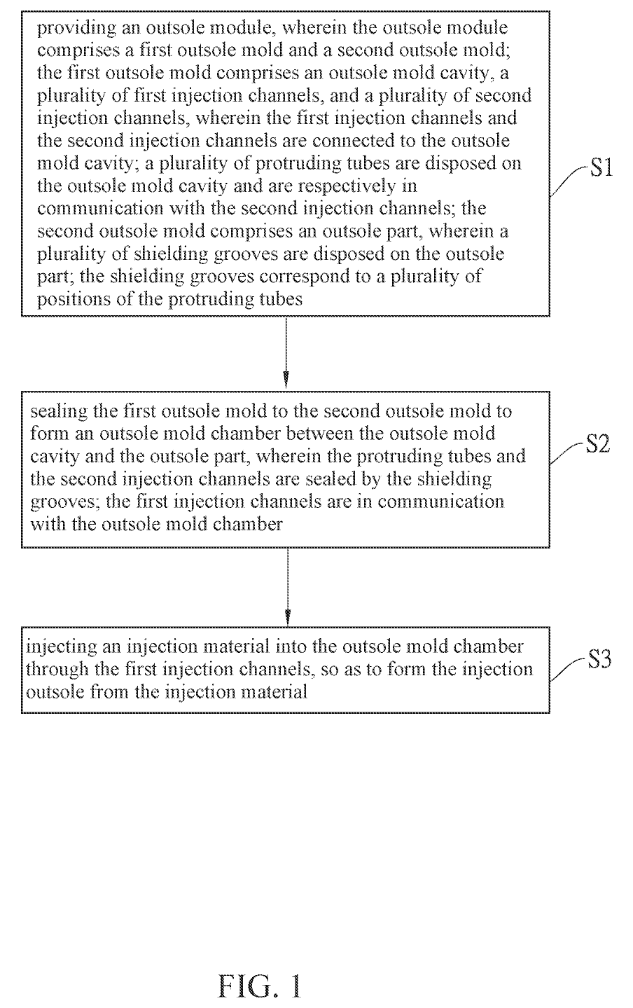

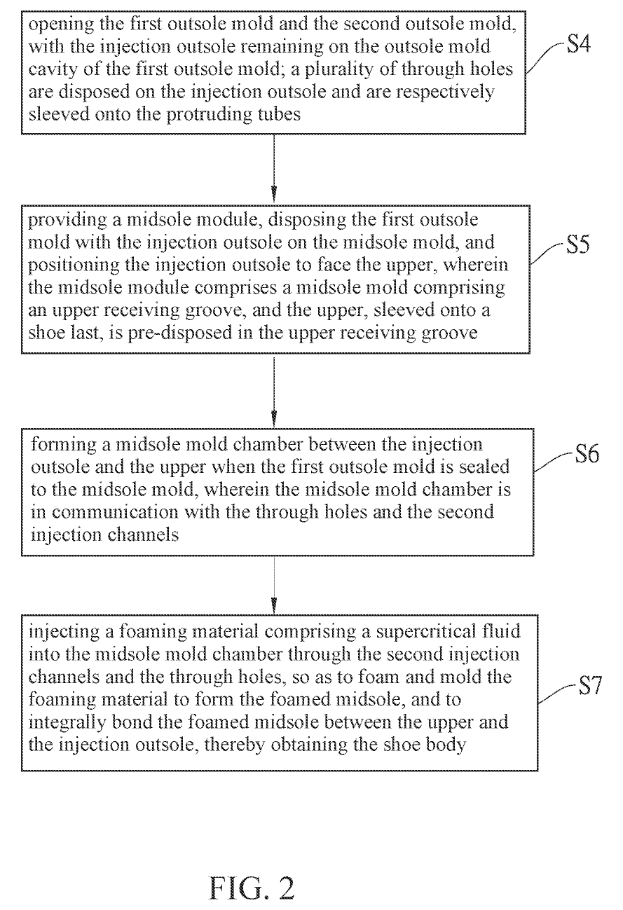

As illustrated in FIGS. 1 and 2, a method for manufacturing a shoe body with a foamed midsole and an injection outsole formed by supercritical foaming injection molding, is configured to manufacture the shoe body 40. The shoe body 40 includes an injection outsole 10, an upper 20, and a foamed midsole 30, wherein the foamed midsole 30 is combined between the upper 20 and the injection outsole 10. The method for manufacturing the shoe body with the foamed midsole and the injection outsole formed by supercritical foaming injection molding includes the following steps:

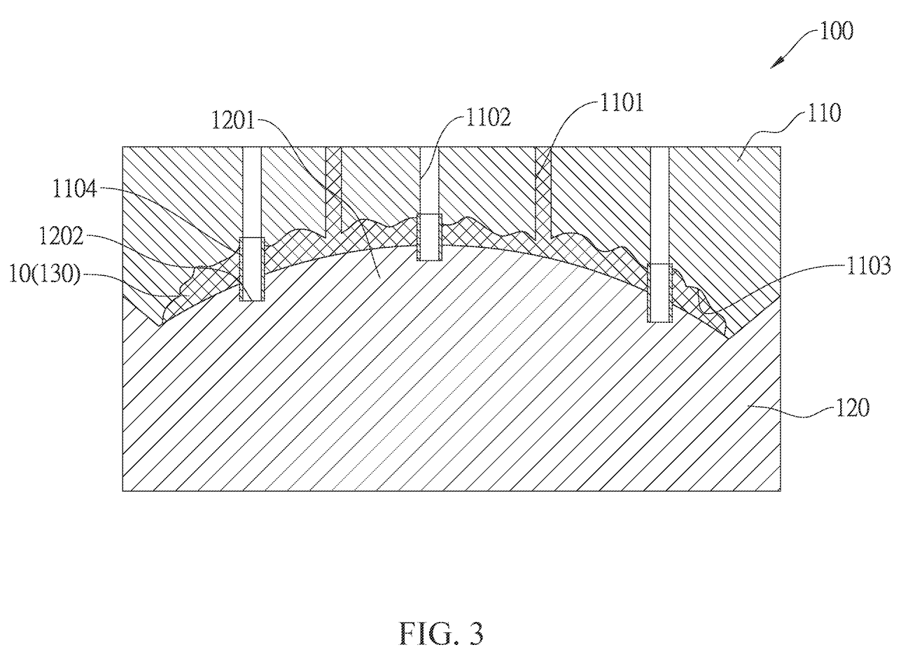

Step S1: providing an outsole module 100. As shown in FIG. 3, the outsole module 100 includes a first outsole mold 110 and a second outsole mold 120, which are movable relative to each other. The first outsole mold 110 includes a plurality of first injection channels 1101, a plurality of second injection channels 1102, and an outsole mold cavity 1103, wherein the first injection channels 1101 and the second injection channels 1102 are connected to the outsole mold cavity 1103. A plurality of protruding tubes 1104 are disposed on the outsole mold cavity 1103 and are respectively in communication with the second injection channels 1102. The second outsole mold 120 includes an outsole part 1201, wherein a plurality of shielding grooves 1202 are disposed on a surface of the outsole part 1201. The shielding grooves 1202 correspond to a plurality of positions of the protruding tubes 1104.

Step S2: sealing the first outsole mold 110 to the second outsole mold 120 to form an outsole mold chamber 130 between the outsole mold cavity 1103 and the outsole part 1201. At this time, the first injection channels 1101 of the first outsole mold 110 are communicated with the outsole mold chamber 130. The protruding tubes 1104 are respectively accommodated in the shielding grooves 1202, so that the protruding tubes 1104 and the second injection channels 1102 are sealed by the shielding grooves 1202, thereby preventing communication between the second injection channels 1102 and the outsole mold chamber 130.

Step S3: injecting an injection material into the outsole mold chamber 130 through the first injection channels 1101 allows the injection material to uniformly fill the outsole mold chamber 130, thereby forming the injection outsole 10 from the injection material. The injection material is selected from a group consisting of rubber, thermoplastic polyurethane elastomer (TPU), thermoplastic polyester elastomer (TPEE), themoplastic vulcanizate (TPV), and a combination thereof. An injection screw temperature of the injection material ranges from 100°C to 300°C.

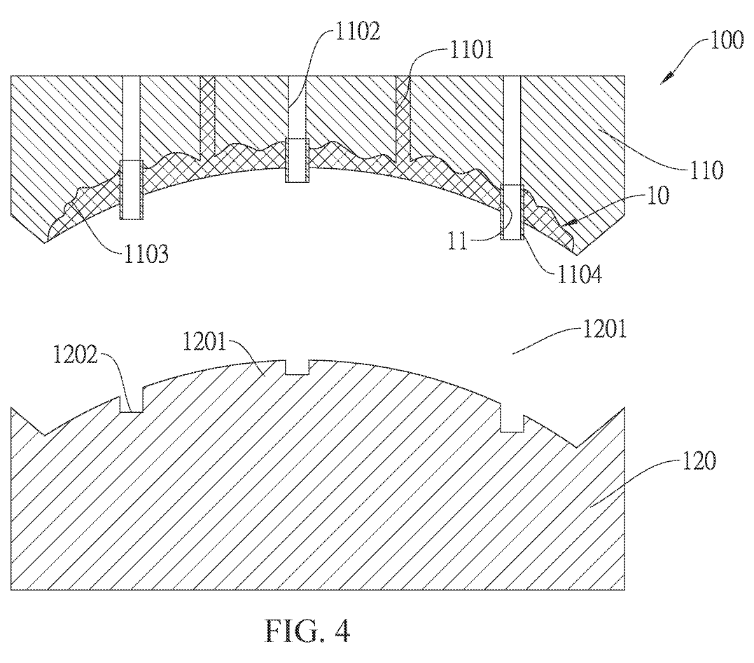

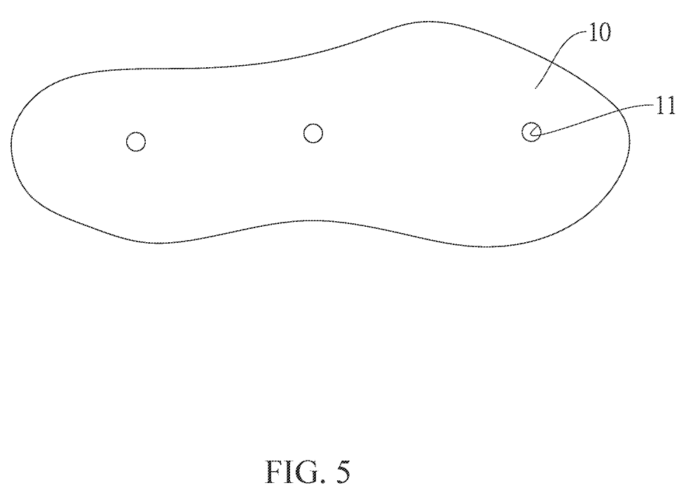

Step S4: opening the first outsole mold 110 and the second outsole mold 120. As shown in FIGS. 4 and 5, at this time, the protruding tubes 1104 of the first outsole mold 110 are detached from the shielding grooves 1202 of the second outsole mold 120, and the injection outsole 10 remains on the outsole mold cavity 1103 of the first outsole mold 110. A plurality of through holes 11 are disposed on the injection outsole 10 and are respectively sleeved onto the protruding tubes 1104. The protruding tube 1104 protrude from the injection outsole 10.

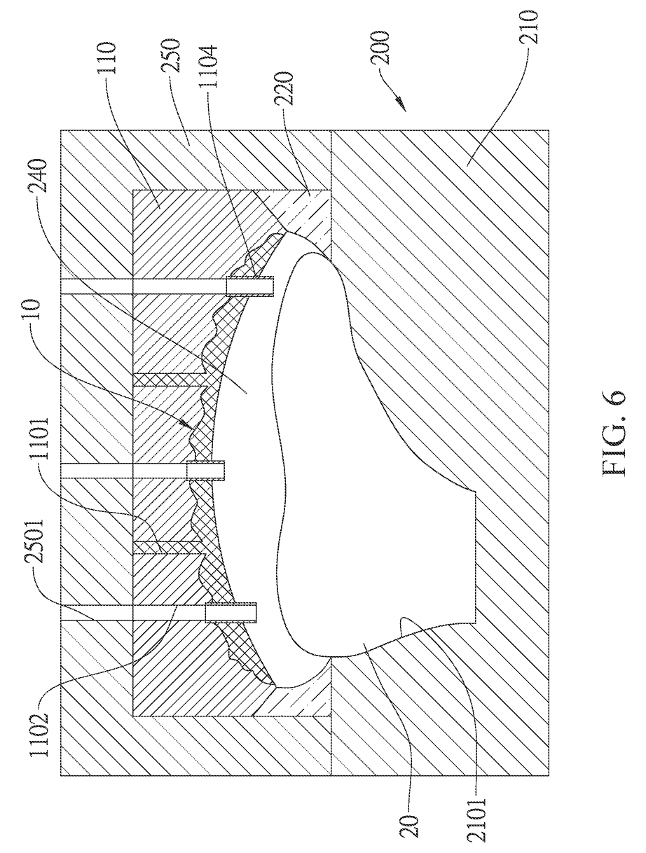

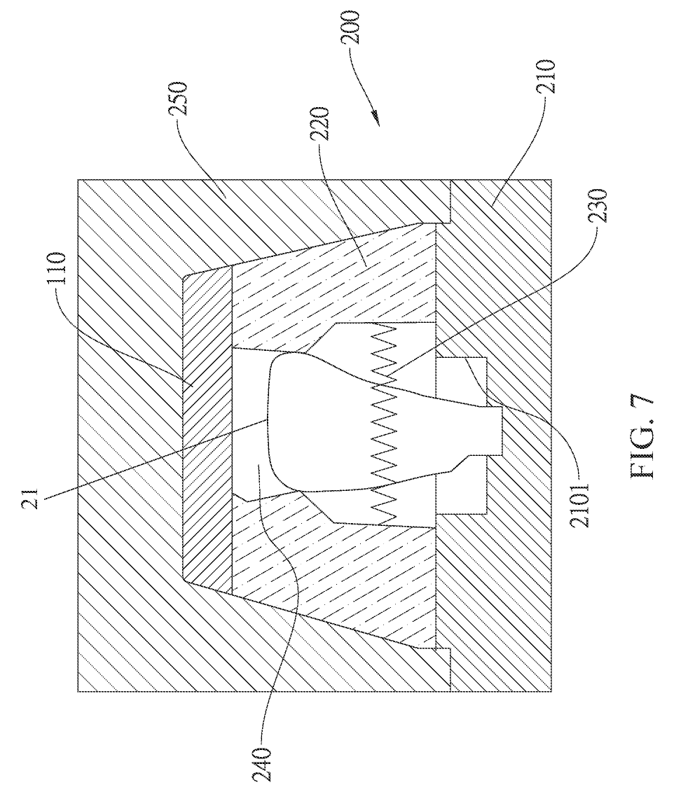

Step S5: providing a midsole module 200. The midsole module 200 includes a midsole mold 210 including an upper receiving groove 2101, wherein the upper 20, sleeved onto a shoe last, is pre-disposed in the upper receiving groove 2101. Disposing the first outsole mold 110 with the injection outsole 10 on the midsole mold 210, and positioning the injection outsole 10 to face the upper 20. As shown in FIGS. 6 and 7, in the current embodiment, two clamping blocks 220 are disposed on the midsole mold 210. When the upper 20, sleeved onto the shoe last, is disposed in the upper receiving groove 2101 of the midsole mold 210, the two clamping blocks 220 are relatively movable and contact two sides of a bottom surface 21 of the upper 20. Therefore, the upper 20 is fixed in the upper receiving groove 2101. Moreover, disposing the first outsole mold 110 with the injection outsole 10 on the two clamping blocks 220 allows the bottom surface 21 of the upper 20 to face the injection outsole 10. A spring 230 is connected between the two clamping blocks 220. The spring 230 normally applies a pushing force to the two clamping blocks 220, but is not limited thereto. In other embodiments, the spring 230 might be omitted, and the two clamping blocks 220 might also be opened and closed by an electric mechanism.

Step S6: in the current embodiment, the midsole module 200 includes a mold cover 250 including a plurality of feeding holes 2501. Sealing the first outsole mold 110 to the midsole mold 210 includes: first placing the mold cover 250 over a periphery of the first outsole mold 110 and a periphery of the two clamping blocks 220, and finally sealing the mold cover 250 to the midsole mold 210. At this time, the two clamping blocks 220 are pushed against the upper 20 by being pressed by the mold cover 250, and the two clamping blocks 220 simultaneously compress the spring 230. A midsole mold chamber 240 is formed between the injection outsole 10 and the upper 20, and is located between the two clamping blocks 220. The midsole mold chamber 240 is in communication with the through holes 11 and the second injection channels 1102. The feeding holes 2501 of the mold cover 250 are respectively in communication with the second injection channels 1102 of the first outsole mold 110.

Step S7: the first injection channels 1101 of the first outsole mold 110 are sealed by the injection outsole 10. Injecting a foaming material including a supercritical fluid into the midsole mold chamber 240 through the feeding holes 2501, the second injection channels 1102, and the through holes 11, so as to foam and mold the foaming material to form the foamed midsole 30, and to integrally bond the foamed midsole 30 between the upper 20 and the injection outsole 10, thereby obtaining the shoe body 40. The supercritical fluid might be nitrogen or carbon dioxide. The foaming material is selected from a group consisting of ethylene-vinyl acetate copolymer (EVA), polyolefin elastomer (POE), styrene-ethylene/butylene-styrene copolymer (SEBS), thermoplastic polyurethane elastomer (TPU), thermoplastic polyester elastomer (TPEE), polyether block amide copolymer (PEBA), and a combination thereof. An injection screw temperature of the foaming material ranges from 100°C to 300°C. In the current embodiment, setting a gas pressure value within the midsole mold chamber 240 before injecting the foaming material into the midsole mold chamber 240, with the gas pressure value ranges from 0 to 40 bar. When the gas pressure value is greater than 0, the gas pressure within the midsole mold chamber 240 is released after the injection of the foaming material, allowing the foaming material to foam and form the foamed midsole 30 within the midsole mold chamber 240. Preferably, the gas pressure value ranges from 5 to 35 bar, but is not limited to this range.

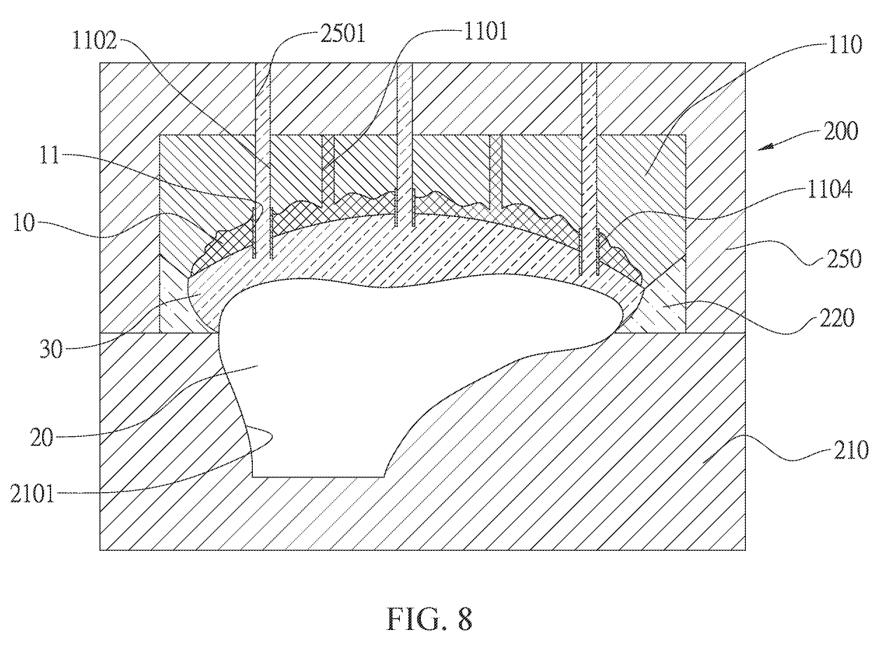

As shown in FIG. 8, when the foaming material foams and molds to form the foamed midsole 30 within the midsole mold chamber 240, the foamed midsole 30 is bonded to the upper 20 and the injection outsole 10, without an adhesive layer being provided between the foamed midsole 30 and the upper 20 or between the foamed midsole 30 and the injection outsole 10. A surface of the foamed midsole 30 that faces away from the upper 20 includes a plurality of protrusions 31. The protrusions 31 are correspondingly embedded in the through holes 11 of the injection outsole 10. In the current embodiments, the foaming material and the injection material might be the same type, so that the foamed midsole 30 and the injection outsole 10 could be integrally bonded by thermal fusion, but the present disclosure is not limited thereto. In other embodiments, the foaming material and the injection material might also be different type, and the foamed midsole 30 and the injection outsole 10 could still be bonded to each other by thermal fusion.

Opening the midsole module 200 includes detaching the mold cover 250 from the first outsole mold 110 and the clamping blocks 220 to release the constraint on the two clamping blocks 220, thereby allowing the spring 230 to resume pushing the two clamping blocks 220 and then releasing the pressure applied by the clamping blocks 220 to the upper 20. Meanwhile, the first outsole mold 110 could be removed from the midsole mold 210 together with the shoe body 40. Subsequently, the shoe body 40 is then demolded and trimmed to complete the finished product.

In the method for manufacturing the shoe body with the foamed midsole and the injection outsole formed by supercritical foaming injection molding, any adhesive application and outsole attaching steps are omitted. After the injection outsole 10 is formed in the outsole module 100, the first outsole mold 110 with the injection outsole 10 is directly sealed to the midsole mold 210 of the midsole module 200. Therefore, a step of removing the injection outsole 10 from the outsole module 100, as well as subsequent trimming and material-filling processes, is omitted. When the first outsole mold 110 is sealed to the midsole mold 210, the foamed midsole 30 is integrally foamed and molded within the midsole mold chamber 240, and is co-molded with the upper 20 and the injection outsole 10 to form the shoe body 40. Accordingly, the method for manufacturing the shoe body with the foamed midsole and the injection outsole formed by supercritical foaming injection molding, compared to conventional manufacturing techniques, not only improves process efficiency, but also reduces mold and labor costs, and even enhances the production yield of the shoe body 40.

Moreover, the steps of the method for manufacturing the shoe body with the foamed midsole and the injection outsole formed by supercritical foaming injection molding could be modified or supplemented as needed. For example, in other embodiments, an insert (not shown) is pre-disposed between the first outsole mold 110 and the midsole mold 210 before sealing the first outsole mold 110 to the midsole mold 210, wherein the insert is a carbon plate or a thermoplastic support plate. The thermoplastic support plate is selected from a group consisting of thermoplastic polyurethane elastomer (TPU), polyether block amide copolymer (PEBA), and a combination thereof. The insert could be pre-disposed on the injection outsole 10. When the first outsole mold 110 is sealed to the midsole mold 210, the insert is fixed in the midsole mold chamber 240, and the foaming material is injected into the midsole mold chamber 240 to cover the insert. When the foaming material foams to form the foamed midsole 30 in the midsole mold chamber 240, the insert might be fixed between the foamed midsole 30 and the injection outsole 10, thereby enhancing the walking support of the shoe body 40, but not limited thereto. The insert could be fixed between the two clamping blocks 220. When the foamed midsole 30 is foamed and molded within the midsole mold chamber 240, the insert is embedded within the foamed midsole 30.

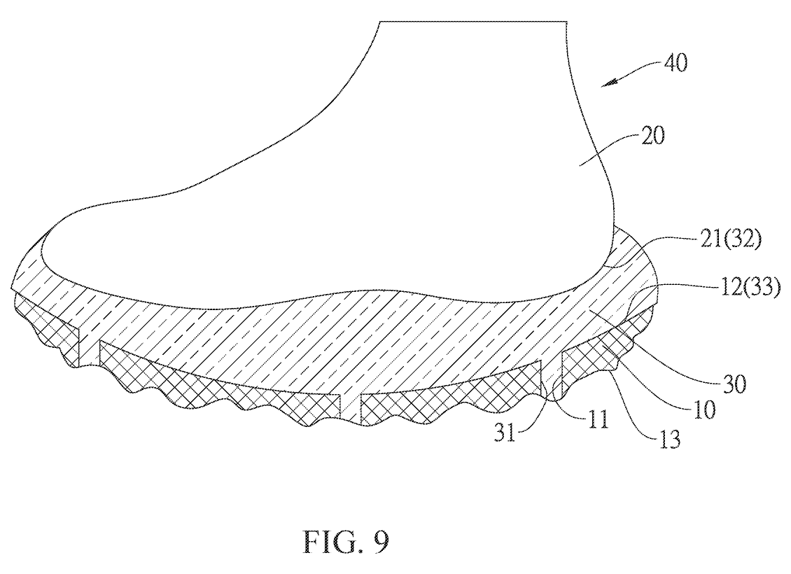

As shown in FIG. 9, the shoe body 40 with the foamed midsole 30 and the injection outsole 10 formed by supercritical foaming injection molding, according to another embodiment in of the present invention, is provided and obtained using the method described in the foregoing embodiment. The shoe body 40 includes the injection outsole 10, the foamed midsole 30, and the upper 20. The foamed midsole 30 is bonded between the injection outsole 10 and the upper 20.

A plurality of through holes 11 are distributed on the injection outsole 10. The injection outsole 10 includes a first top surface 12 and a first bottom surface 13, wherein the through holes 11 penetrate the first top surface 12 and the first bottom surface 13. A density of the injection outsole 10 ranges from 0.8 to 1.4 g/cm³. The injection outsole 10 is selected from a group consisting of rubber, thermoplastic polyurethane elastomer (TPU), thermoplastic polyester elastomer (TPEE), themoplastic vulcanizate (TPV), and a combination thereof.

The foamed midsole 30 includes the protrusions 31, a second top surface 32, and a second bottom surface 33. The protrusions 31 are located on the second bottom surface 33. The second bottom surface 33 of the foamed midsole 30 is bonded to the first top surface 12 of the injection outsole 10. The protrusions 31 of the foamed midsole 30 are correspondingly embedded in the through holes 11 of the injection outsole 10. A density of the foamed midsole 30 ranges from 0.1 to 0.3 g/cm³. The foamed midsole 30 is selected from a group consisting of ethylene-vinyl acetate copolymer (EVA), polyolefin elastomer (POE), styrene-ethylene/butylene-styrene copolymer (SEBS), thermoplastic polyurethane elastomer (TPU), thermoplastic polyester elastomer (TPEE), polyether block amide copolymer (PEBA), and a combination thereof. Preferably, the density and a hardness of the foamed midsole 30 and the density and a hardness of the injection outsole 10 could be differ from each other. For example, the hardness of the injection outsole 10 is greater than the hardness of the foamed midsole 30. Therefore, a user wears the shoe body 40 more comfortably and walk with greater stability.

The bottom surface 21 of the upper 20 is bonded to the second top surface 32 of the foamed midsole 30. The second top surface 32 of the foamed midsole 30 is bonded to the bottom surface 21 of the upper 20 by thermal fusion, without the adhesive layer being provided between the foamed midsole 30 and the upper 20. The second bottom surface 33 of the foamed midsole 30 is bonded to the first top surface 12 of the injection outsole 10 by thermal fusion, without the adhesive layer being provided between the foamed midsole 30 and the injection outsole 10. In the current embodiment, the upper 20 is exemplified using a mesh woven fabric. A portion of the foamed midsole 30 enters a plurality of pores of the bottom surface 21 of the upper 20, thereby bonding the foamed midsole 30 to the upper 20; however, this is not limited thereto. In other embodiments, the bottom surface 21 of the upper 20 might undergo surface treatment to form a rough surface, which increases a contact area between the second top surface 32 of the foamed midsole 30 and the bottom surface 21 of the upper 20, thereby also achieving a bonding effect between the foamed midsole 30 and the upper 20.

In the shoe body 40 with the foamed midsole 30 and the injection outsole 10 formed by supercritical foaming injection molding, the foamed midsole 30 is bonded between the upper 20 and the injection outsole 10, without any adhesive layer between the foamed midsole 30 and the upper 20, or between the foamed midsole 30 and the injection outsole 10. Moreover, the protrusions 31 of the foamed midsole 30 are correspondingly embedded in the through holes 11 of the injection outsole 10, thereby enhancing the bonding strength between the foamed midsole 30 and the injection outsole 10 and improving the overall bonding performance.

It must be pointed out that the embodiment described above is only a preferred embodiment of the present invention. All equivalent composites and methods which employ the concepts disclosed in this specification and the appended claims should fall within the scope of the present invention.

What is claimed is:

1. A method for manufacturing a shoe body with a foamed midsole and an injection outsole formed by supercritical foaming injection molding, wherein the shoe body comprises the injection outsole, the foamed midsole, and an upper; the foamed midsole is bonded between the upper and the injection outsole; the method comprising the steps of:
step S1: providing an outsole module, wherein the outsole module comprises a first outsole mold and a second outsole mold; the first outsole mold comprises an outsole mold cavity, a plurality of first injection channels, and a plurality of second injection channels, wherein the first injection channels and the second injection channels are connected to the outsole mold cavity; a plurality of protruding tubes are disposed on the outsole mold cavity and are respectively in communication with the second injection channels; the second outsole mold comprises an outsole part, wherein a plurality of shielding grooves are disposed on the outsole part; the shielding grooves correspond to a plurality of positions of the protruding tubes;
step S2: sealing the first outsole mold to the second outsole mold to form an outsole mold chamber between the outsole mold cavity and the outsole part, wherein the protruding tubes and the second injection channels are sealed by the shielding grooves; the first injection channels are in communication with the outsole mold chamber;
step S3: injecting an injection material into the outsole mold chamber through the first injection channels, so as to form the injection outsole from the injection material;
step S4: opening the first outsole mold and the second outsole mold, with the injection outsole remaining on the outsole mold cavity of the first outsole mold; a plurality of through holes are disposed on the injection outsole and are respectively sleeved onto the protruding tubes;
step S5: providing a midsole module, disposing the first outsole mold with the injection outsole on the midsole mold, and positioning the injection outsole to face the upper, wherein the midsole module comprises a midsole mold comprising an upper receiving groove, and the upper, sleeved onto a shoe last, is pre-disposed in the upper receiving groove;
step S6: forming a midsole mold chamber between the injection outsole and the upper when the first outsole mold is sealed to the midsole mold, wherein the midsole mold chamber is in communication with the through holes and the second injection channels; and
step S7: injecting a foaming material comprising a supercritical fluid into the midsole mold chamber through the second injection channels and the through holes, so as to foam and mold the foaming material to form the foamed midsole, and to integrally bond the foamed midsole between the upper and the injection outsole, thereby obtaining the shoe body.

2. The method as claimed in claim 1, wherein two clamping blocks are disposed on the midsole mold; when the upper, sleeved onto the shoe last, is disposed on the midsole mold, the two clamping blocks are relatively movable and contact two sides of a bottom surface of the upper; in step S5, the first outsole mold is located between the two clamping blocks.

3. The method as claimed in claim 2, wherein the midsole module comprises a mold cover comprising a plurality of feeding holes; sealing the first outsole mold to the midsole mold includes: first placing the mold cover over a periphery of the first outsole mold and a periphery of the two clamping blocks, and finally sealing the mold cover to the midsole mold; the midsole mold chamber is located between the two clamping blocks; the feeding holes are in communication with the second injection channels of the first outsole mold.

4. The method as claimed in claim 1, wherein when the foaming material foams and molds to form the foamed midsole in the midsole mold chamber, the foamed midsole is bonded to the upper and the injection outsole by thermal fusion, without an adhesive layer being provided between the foamed midsole and the upper and between the foamed midsole and the injection outsole; the foamed midsole has a plurality of protrusions correspondingly embedded in the through holes of the injection outsole.

5. The method as claimed in claim 1, wherein an insert is pre-disposed between the first outsole mold and the midsole mold before sealing the first outsole mold to the midsole mold; when the first outsole mold is sealed to the midsole mold, the insert is fixed in the midsole mold chamber, and the foaming material is injected into the midsole mold chamber to cover the insert.

6. The method as claimed in claim 5, wherein the insert is a carbon plate or a thermoplastic support plate; the thermoplastic support plate is selected from a group consisting of thermoplastic polyurethane elastomer (TPU), polyether block amide copolymer (PEBA), and a combination thereof.

7. The method as claimed in claim 1, wherein the injection material is selected from a group consisting of rubber, thermoplastic polyurethane elastomer (TPU), thermoplastic polyester elastomer (TPEE), themoplastic vulcanizate (TPV), and a combination thereof; an injection screw temperature of the injection material ranges from 100°C to 300°C.

8. The method as claimed in claim 1, further comprising setting a gas pressure value within the midsole mold chamber before injecting the foaming material into the midsole mold chamber, with the gas pressure value ranges from 0 to 40 bar; the supercritical fluid is nitrogen or carbon dioxide.

9. The method as claimed in claim 1, wherein the foaming material is selected from a group consisting of ethylene-vinyl acetate copolymer (EVA), polyolefin elastomer (POE), styrene-ethylene/butylene-styrene copolymer (SEBS), thermoplastic polyurethane elastomer (TPU), thermoplastic polyester elastomer (TPEE), polyether block amide copolymer (PEBA), and a combination thereof; an injection screw temperature of the foaming material ranges from 100°C to 300°C.

10. A shoe body with a foamed midsole and an injection outsole formed by supercritical foaming injection molding, comprising:
an injection outsole comprising a first top surface and a first bottom surface, wherein a plurality of through holes are distributed on the injection outsole; the through holes penetrate the first top surface and the first bottom surface;
a foamed midsole comprising a second top surface and a second bottom surface, wherein the second bottom surface is bonded to the first top surface; the foamed midsole comprises a plurality of protrusions located on the second bottom surface; the protrusions are correspondingly embedded in the through holes of the injection outsole; and
an upper bonded to the foamed midsole, wherein the upper comprises a bottom surface; the bottom surface is bonded to the second top surface of the foamed midsole.

11. The shoe body as claimed in claim 10, wherein the second top surface of the foamed midsole is bonded to the bottom surface of the upper by thermal fusion, without an adhesive layer being provided between the foamed midsole and the upper; the second bottom surface of the foamed midsole is bonded to the first top surface of the injection outsole by thermal fusion, without an adhesive layer being provided between the foamed midsole and the injection outsole.

12. The shoe body as claimed in claim 10, wherein the injection outsole is selected from a group consisting of rubber, thermoplastic polyurethane elastomer (TPU), thermoplastic polyester elastomer (TPEE), themoplastic vulcanizate (TPV), and a combination thereof.

13. The shoe body as claimed in claim 10, wherein the foamed midsole is selected from a group consisting of ethylene-vinyl acetate copolymer (EVA), polyolefin elastomer (POE), styrene-ethylene/butylene-styrene copolymer (SEBS), thermoplastic polyurethane elastomer (TPU), thermoplastic polyester elastomer (TPEE), polyether block amide copolymer (PEBA), and a combination thereof.

14. The shoe body as claimed in claim 10, wherein a density of the injection outsole ranges from 0.8 to 1.4 g/cm³, and a density of the foamed midsole ranges from 0.1 to 0.3 g/cm³.
